(19) United States
(12) Patent Application Publication
(10) Pub. No.: US 2015/0372398 A1
(43) Pub. Date: Dec. 24, 2015

(54) Method and Apparatus for Generating Electromagnetic Beams

(71) Applicant: Huawei Technologies Co., Ltd., Shenzhen (CN)

(72) Inventors: Sergey Nikolaevich Dudorov, Moscow (RU); Yanxing Zeng, Hangzhou (CN); Jianqiang Shen, Hangzhou (CN); Igor Mikhailovich Punkov, Moscow (RU)

(21) Appl. No.: 14/752,359

(22) Filed: Jun. 26, 2015

Related U.S. Application Data
(63) Continuation of application No. PCT/RU2012/001115, filed on Dec. 26, 2012.

(51) Int. Cl. H01Q 25/04; H01Q 19/17; H01Q 3/40

(52) U.S. Cl. CPC H01Q 25/04; H01Q 3/40; H01Q 19/17

(57) ABSTRACT

The invention relates to a method and apparatus for generating and/or receiving electromagnetic beams with variable orbital angular momentum (OAM) states. The antenna array comprises antenna elements adapted to generate or receive electromagnetic beams with variable OAM. The antenna elements are arranged uniformly in an array plane of the antenna array along a circle. Input signal vectors of input data streams are multiplied with a beam-forming matrix to calculate transmit signal vectors applied to the antenna elements to generate the electromagnetic beams with variable OAM states. Reception signal vectors provided by antenna elements in response to incident electromagnetic beams with variable OAM states are multiplied with the beam-forming matrix to calculate output signal vectors of output data streams. The antenna array is supplemented by a collimating element.

### CROSS-REFERENCE TO RELATED APPLICATIONS

This application is a continuation of International Application No. PCT/RU2012/001115, filed on Dec. 26, 2012, which is hereby incorporated by reference in its entirety.

### TECHNICAL FIELD

The invention relates to a method and apparatus for receiving electromagnetic beams with variable orbital angular momentum (OAM) states.

### BACKGROUND

The orbital angular momentum of light (OAM) is a component of angular momentum of an electromagnetic beam that is dependent on the field spatial distribution and not on the polarization. The orbital angular momentum of light, or electromagnetic wave, can be associated with a helical or twisted wave front.

The most common way to produce an optical beam carrying an orbital angular momentum state is a hologram. The difference of an electromagnetic wave with an OAM state and an ordinary conventional electromagnetic wave is that, when taking a time snapshot, twisted surfaces instead of plain surfaces can be found in an electromagnetic wave with an OAM state in which the electromagnetic field is zero. In other words, the electromagnetic wave carrying an OAM has a wave front with a twisted shape. Another difference is that for such an electromagnetic beam or electromagnetic wave carrying an OAM there is a field minimum in its propagation axis. In order to properly use such an electromagnetic beam for a communication purpose, the center of this electromagnetic beam carrying an OAM where the electromagnetic field is zero, must hit the center of a receiving antenna system.

An experimental demonstration of a simultaneous transmission of two indication data streams at a predetermined distance using electromagnetic beams carrying different orbital angular momenta, namely 0 and 1, at microwave frequencies has been described by Fabrizio Tamburini, Elettra Mari, Anna Sponselli, Bo Thide, Antonio Bianchini, and Filippo Romanato, “Encoding many channels on the same frequency through the radio vorticity” in New Journal of Physics, 14 (033001), 2012. This experimental setup is illustrated in FIG. 1.

An antenna able to transmit and receive radio transmissions that have an OAM polarisation in addition to a spin or circular polarisation has been described in the UK Patent application GB2410130A.

The twisted shape of a reflector is supposed to be periodically repeated by the wave front of the radiated electromagnetic beam to form a smooth twisted surface. In the experimental setup shown in FIG. 1 it was found that there exists a singularity area, where the radiated electromagnetic field is weak. As a result in the experimental setup, a modified reflector antenna has not been used at the receiving side as shown in FIG. 1. Instead, the differential output from two widely spaced antennas was received in order to decode the OAM carrying an electromagnetic beam shown on the right side of FIG. 1. In order to receive electromagnetic beams of two types at the same time separate conventional antennas have been added at both the transmitting and receiving side illustrated as Yagi-Uda antennas at the left side and in the middle of the right side of FIG. 1.

Conventional multiple input, multiple output (MIMO) systems use multiple antennas at both the transmitter and receiver to improve the communication performance. In MIMO systems, the total transmit power is spread over different antennas to achieve an array gain that improves the spectral efficiency or to achieve a diversity gain that improves the link reliability (reduced fading). Conventional MIMO systems use typically a linear antenna array or a uniform circular array in which the generated electromagnetic beams are radiated in the plane of the array, so-called azimuthal array.

In line-of-sight (LOS) communication, antenna elements have to be separated because the useful communication distance strongly depends on the so-called Rayleigh distance. At large communication distances, only one MIMO eigen vector (for a single polarization) has a relatively high eigen value and can provide a good transmission channel. In a noisy environment, all other MIMO channels have low capacities because of a strong signal attenuation. This results in a low overall capacity, and thus the higher MIMO modes are the bottlenecks of the LOS MIMO system.

Accordingly, there is a need for a method and apparatus which provide for a lower signal attenuation.

### SUMMARY

According to a first aspect of the present invention an antenna array is provided.

According to a first possible implementation of the antenna array according to the first aspect of the present invention the antenna array comprises antenna elements arranged along a circle adapted to generate or receive electromagnetic beams with variable OAM states.

In a possible second implementation of the first implementation of the antenna array according to the first aspect of the present invention, the antenna elements are arranged uniformly in an array plane of said antenna array along said circle.

In a further third implementation of the first or second implementation of the antenna array according to the first aspect of the present invention, the antenna elements of the antenna array are connected via connection lines to an antenna array feeding circuit.

In a further possible fourth implementation of the third implementation of the antenna array according to the first aspect of the present invention, the antenna array feeding circuit is adapted in a transmitting regime to provide transmit signal vectors applied to said antenna elements of said antenna array by multiplying a beam-forming matrix with input signal vectors corresponding to active input ports.

In a further possible fifth implementation of the first to fourth implementation of the antenna array according to the first aspect of the present invention, the antenna array feeding circuit is further adapted in a receiving regime to calculate output signal vectors by multiplying the beam-forming matrix with reception signal vectors received from said antenna elements of said antenna array.

In a further possible sixth implementation of the first to fifth implementation of the antenna array according to the first aspect of the present invention, the antenna elements of said antenna array are arranged in the array plane which has an orientation being normal to the propagation direction of the electromagnetic beams generated or received by said antenna array.

In a further possible seventh implementation of the sixth implementation of the antenna array according to the first aspect of the present invention, the array plane of said antenna array is located at the focal plane of a collimating element.

In a further possible eighth implementation of the seventh implementation of the antenna array according to the first aspect of the present invention, the collimating element comprises a parabolic reflector.

In a further possible ninth implementation of the seventh implementation of the antenna array according to the first aspect of the present invention, the collimating element comprises a collimating lens.

In a further possible tenth implementation of the seventh implementation of the antenna array according to the first aspect of the present invention, the collimating element comprises a diffraction grating.

In a further possible eleventh implementation of the first to tenth implementation of the antenna array according to the first aspect of the present invention, the antenna array elements of the antenna array are arranged around the common axis in a plane being parallel to a base plane of the conical lens.

In a further possible twelfth implementation of the eleventh implementation of the antenna array according to the first aspect of the present invention, the conical lens is adapted to transform incident Lagger-Gaussian electromagnetic beams radiated by said antenna array to a base plane of said conical lens into Bessel electromagnetic beams.

In a further possible thirteenth implementation of the eleventh or twelfth implementation of the antenna array according to the first aspect of the present invention, the conical lens is further adapted to transform incident Bessel electromagnetic beams applied to the lateral surface of said conical lens into Lagger-Gaussian electromagnetic beams applied to said antenna array.

In a further possible fourteenth implementation of the first to thirteenth implementation of the antenna array according to the first aspect of the present invention, the antenna elements comprise directive antenna elements.

In a possible fifteenth implementation of the first to fourteenth implementation of the antenna array according to the first aspect of the present invention, the antenna elements within said circular antenna array are connected to output ports of a feeding circuit.

In a further possible sixteenth implementation of the fifteenth implementation of the antenna array according to the first aspect of the present invention, the antenna elements within said circular antenna array are connected via transmission lines and signal coupling elements to the output ports of the feeding circuit.

In a further possible seventeenth implementation of the third to sixteenth implementation of the antenna array according to the first aspect of the present invention, the antenna array feeding circuit comprises a baseband/radio frequency converter adapted to perform a transformation between a baseband signal and a radio frequency signal, and an RF signal distributing circuit used by said antenna elements.

In a further possible eighteenth implementation of the first to seventeenth implementation of the antenna array according to the first aspect of the present invention, the antenna array is adapted to radiate electromagnetic beams to a remote antenna array and to receive electromagnetic beams from a remote antenna array.

In a further possible nineteenth implementation of the third to eighteenth implementation of the antenna array according to the first aspect of the present invention, the antenna array and the antenna array feeding circuit are integrated on a printed circuit board.

In a further possible twentieth implementation of the fifth to nineteenth implementation of the antenna array according to the first aspect of the present invention, the beam-forming matrix consists of N×N complex beam-forming matrix elements Bmi, wherein Bmi is determined according to the following relationship:

$$Bmi = {k}_{m} \cdot {e}^{\pm j \cdot \frac{2 Π}{N} m \cdot i} ,$$

where N is the total number of antenna elements within said antenna array,

$$m = 0 , \pm 1 , \pm 2 … \leq \frac{N}{2} ,$$

is a OAM state number of a OAM state, i=0, 1, 2 . . . N−1 is the number of a particular antenna element within the antenna array, and kₘ is the normalizing coefficient.

According to a further second aspect of the present invention a MIMO antenna system is provided comprising at least one antenna array according to one of the possible implementations of the antenna array according to the first aspect of the present invention.

According to a further third aspect the invention provides a point-to-point communication system.

In a possible implementation of the point-to-point communication system according to the third aspect of the present invention the point-to-point communication system comprises at least one transmitting antenna array having antenna elements arranged along a circle adapted to generate electromagnetic beams with variable OAM states, and at least one receiving antenna array having antenna elements arranged along a circle adapted to receive electromagnetic beams with variable OAM states.

According to a fourth aspect of the present invention a method for generating electromagnetic beams with variable OAM states is provided.

According to a possible implementation of the method for generating electromagnetic beams with OAM states according to the fourth aspect of the present invention input signal vectors of input data streams are multiplied with a beam-forming matrix from the left side to calculate transmit signal vectors applied to antenna elements arranged uniformly along a circle in an array plane of an antenna array to generate said electromagnetic beams with variable OAM states.

According to a fifth aspect of the present invention a method for receiving electromagnetic beams with variable OAM states is provided.

According to a possible implementation of the method for receiving electromagnetic beams with variable OAM states according to the fifth aspect of the present invention reception signal vectors provided by antenna elements arranged uniformly along a circle in an array plane of an antenna array in response to incident electromagnetic beams with variable OAM states are multiplied from the left side by a beam-forming matrix to calculate output signal vectors of output data streams.

### BRIEF DESCRIPTION OF THE DRAWINGS

In the following, possible implementations of different aspects of the present invention are described with reference to the enclosed figures in detail.

FIG. 1 shows an experimental setup of simultaneous transmission of two signals according to the state of the art;

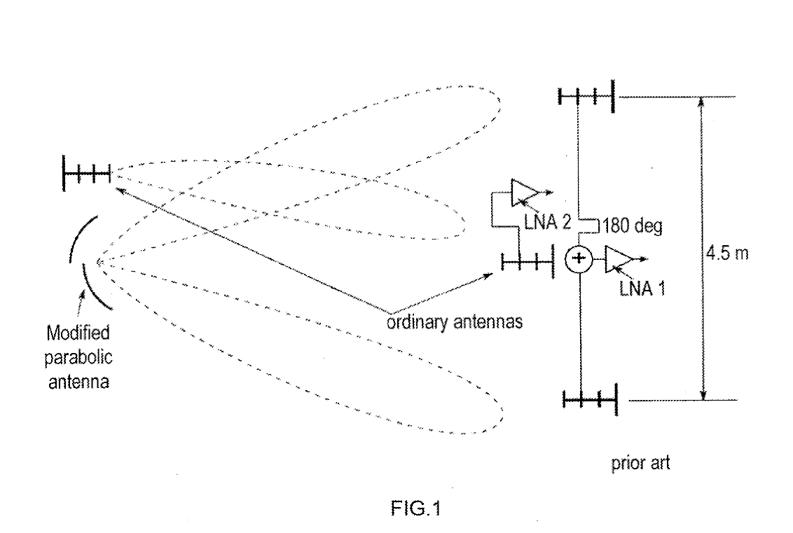

FIG. 2 shows a diagram for illustrating a possible implementation of an antenna array according to the first aspect of the present invention;

FIG. 3 shows a diagram for illustrating a possible implementation of an antenna array according to the first aspect of the present invention;

FIG. 4 shows a possible implementation of a multiple input and multiple output, MIMO, antenna system according to a further aspect of the present invention;

FIG. 5 shows a block diagram for a possible implementation of an antenna array according to an aspect of the present invention;

FIG. 6 shows a point-to-point communication system according to a further aspect of the present invention;

FIG. 7 shows a diagram for illustrating a further possible implementation of a point-to-point communication system according to a further aspect of the present invention;

FIG. 8 shows a diagram for illustrating a possible implementation of a multiple input and multiple output antenna system according to an aspect of the present invention;

FIG. 9 shows a diagram for illustrating a possible implementation of a multiple input and multiple output antenna system according to an aspect of the present invention;

FIG. 10 shows a diagram for illustrating a field distribution generated in a possible implementation of the antenna array according to an aspect of the present invention; and

FIG. 11 shows a possible implementation of a parabolic two-port antenna system as used in the antenna array according to the first aspect of the present invention.

### DETAILED DESCRIPTION OF ILLUSTRATIVE EMBODIMENTS

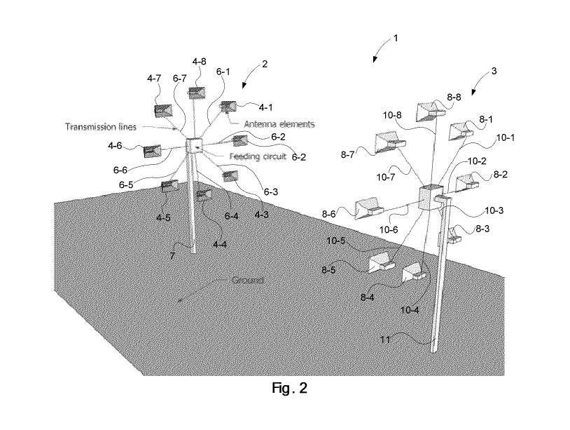

FIG. 2 shows a possible implementation of a point-to-point communication system 1 according to an aspect of the present invention having at least one transmitting antenna array 2 and at least one receiving antenna array 3.

The transmitting antenna array 2 and the receiving antenna array 3 form possible embodiments of an antenna array according to the first aspect of the present invention. At least one transmitting antenna array 2 shown in FIG. 2 has antenna elements 4-1 arranged along a circle and adapted to generate electromagnetic beams with OAM states. In the shown implementation of FIG. 2 4 the transmitting antenna array comprises 8 antenna elements 4-1 to 4-8 arranged along a circle and connected to a feeding circuit 5. The feeding circuit 5 can be connected to all antenna elements 4-i of the transmitting antenna array 2 by means of transmission lines 6-i as illustrated in FIG. 2. The feeding circuit 5 can be mounted to an antenna mast 7 as shown in FIG. 2. The antenna mast 7 can be fixed to ground.

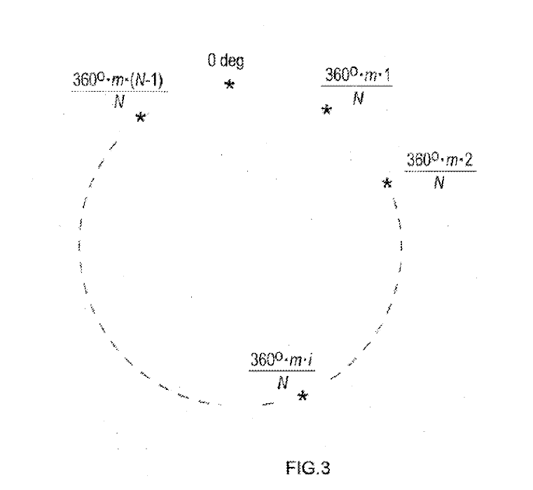

In the shown implementation of FIG. 2 the receiving antenna array 3 is arranged in a similar manner as the transmitting antenna array 2. The receiving antenna array 3 comprises antenna elements 8-1 to 8-8 connected to a feeding circuit 9 in the center of the receiving antenna array 3 and connected to the antenna elements 8-i via transmission lines 10-i as illustrated in FIG. 2. The arrangement can be mounted to an antenna mast 11 being fixed to ground. The receiving antenna array 3 has the antenna elements 8-i arranged along a circle adapted to receive electromagnetic beams with variable OAM states from the transmitting array 2. In a possible implementation the antenna elements 4-i of the transmitting antenna array 2 and the receiving antenna elements 8-i of the receiving antenna array 3 are arranged uniformly in an array plane of the respective antenna array along a circle. This is also illustrated in FIG. 3. FIG. 3 shows schematically the arrangement of antenna elements and feeding phases in an antenna array comprising N different antenna elements wherein m is the number of the OAM state with

$$m = 0 , \pm 1 , \pm 2 … \leq \frac{N}{2} .$$

The number N of antenna elements within the antenna array 2, 3 can vary. Also the diameter of the circle around the center can be different depending on the application of the antenna array.

As shown in FIG. 2 the antenna elements 4-i of the transmitting antenna array 2 are connected via connection lines 6-i to an antenna array feeding circuit 5 at the antenna mast 7. The antenna array feeding circuit 5 is adapted to provide in a transmitting regime transmit signal vectors applied to the antenna elements 4-i of the antenna array by multiplying a beam-forming matrix, B, with input signal vectors corresponding to active input ports. Moreover, the antenna array feeding circuit 5 is adapted to calculate in the receiving regime output signal vectors by multiplying the beam-forming matrix, B, with reception signal vectors received from said antenna elements 4-I of said antenna array 2.

In a possible implementation of the point-to-point communication system 1 as illustrated in FIG. 2 the antenna elements 4-i of the transmitting antenna array are adapted to generate electromagnetic beams with variable OAM states, whereas the antenna elements 8-i of the receiving antenna array 3 are adapted to receive electromagnetic beams with variable OAM states. In a further possible implementation of the point-to-point communication system 1 as illustrated in FIG. 2 the antenna elements 4-i as well as the antenna elements 8-i of both antenna arrays 2, 3 are adapted to generate and to receive electromagnetic beams with variable OAM states. Accordingly, in this implementation the antenna array 2, 3 can both work or operate as a transmitting antenna array and as a receiving antenna array.

The antenna elements of the antenna array 2, 3 are arranged in an array plane which has an orientation being normal to a propagation direction of the electromagnetic beams generated or received by the respective antenna array 2, 3.

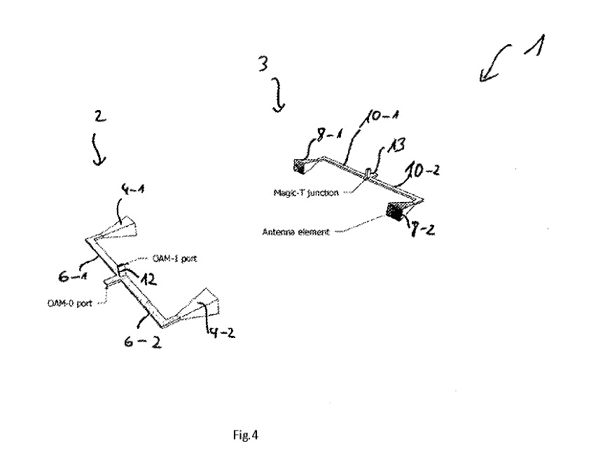

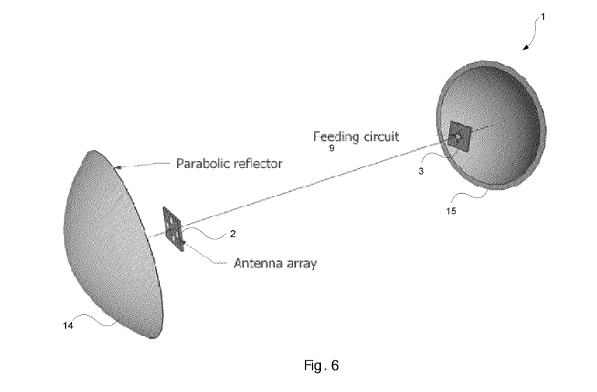

In a possible implementation the array plane of the antenna array is located at the focal plane of a collimating element. This collimating element can be a parabolic reflector as illustrated for example in FIG. 6. In an alternative implementation the collimating element can also comprise a collimating lens. In a still further possible implementation the collimating element can also be formed by a diffraction grating. In a further possible implementation of the antenna array 2, 3 according to the first aspect of the present invention, the antenna array can be arranged around the common axis in a plane being parallel to a base plane of a conical lens. As illustrated also in FIG. 4, this conical lens is adapted to transform incident Lagger-Gaussian electromagnetic beams radiated by the antenna array 2, 3 to a base plane of the conical lens into Bessel electromagnetic beams. Further, the conical lens can be adapted to transform incident Bessel electromagnetic beams applied to a lateral surface of the conical lens into Lagger-Gaussian electromagnetic beams applied to the antenna array 2, 3.

The antenna elements 4-i, 8-i of the antenna array 2, 3 according to the first aspect of the present invention as illustrated in FIG. 2 can comprise directive antenna elements. The antenna elements in the circular antenna array can be connected to data stream ports of input/output data streams. The antenna feeding circuit 5 as shown in FIG. 2 can comprise in a possible implementation a baseband/radio frequency converter adapted to perform a transformation between a baseband signal and a radio frequency signal used by the antenna elements 4-i of the antenna array 2. The antenna array 2 is adapted to radiate electromagnetic beams to the remote antenna array 3 and can be at the same time adapted to receive electromagnetic beams from the remote antenna array 3. In a possible implementation of the antenna array 2, 3 according to the first aspect of the present invention, the antenna elements of the antenna array as well as the antenna array feeding circuit 5, 9 can be integrated on a printed circuit board, PCB. The point-to-point communication system 1 as illustrated in FIG. 2 uses electromagnetic beams with OAM states in a working antenna array system, wherein the propagation direction of the electromagnetic beams is normal to the array plane. The circular antenna array 2, 3 can be basically constructed from a linear beam-forming array by rearranging the antenna elements from a linear arrangement to a circular configuration as shown in FIG. 2. Accordingly, it is possible to apply similar beam-forming matrix vectors without a major software modification. The antenna array 2 with antenna elements that are arranged uniformly in an array plane of said antenna array along a circle and a feeding circuit 5 in the center connected to the antenna elements 4-i by means of connection lines 6-i receives input signal vectors which are multiplied with a beam-forming matrix, B, to provide transmit signal vectors applied to the antenna elements 4-i of the transmitting antenna array 2. In this way, electromagnetic beams are produced or generated, but, in contrast to a conventional beam-forming process, the OAM states are varied rather than the spatial directions of the beams. In the receiving regime the antenna array 3 according to a possible implementation is adapted in the receiving regime to calculate output signal vectors by multiplying the beam-forming matrix, B, with reception signal vectors received from the antenna elements 8-i of the respective antenna array 3.

In order to generate an electromagnetic beam with an OAM state one can provide an aperture with a circular phase distribution which can be written as A(r)·e^{j·m·φ}, wherein A(r) is a function determining the amplitude of the electromagnetic field, which depends only on the distance from the beam center and wherein e^{j·m·φ} is the signal component giving the field phase, m=0, ±1, ±2, ±3, . . . is the OAM state number, and φ=0 . . . 2π is the angle where the antenna element is placed. In case of a finite number of an antenna elements 4-i, 8-i, the antenna elements can be placed in a possible implementation uniformly around a circle at angles φᵢ=i·2π/N, i=0, 1, 2, . . . N−1. Each transmitting antenna element 4-i is excited with a corresponding complex amplitude of A(r)·e^{j·m·φ}^{ᵢ}. The value of the amplitude A(r) can be constant because of the circular configuration of the antenna elements within the antenna array comprising a constant radius or diameter. Therefore, the complex excitation amplitudes of the antenna elements 4-i within the antenna array 2 can be written as xᵢ=e^{j·m·i2π/N}. If the OAM state number m=0, 1, 2, 3 . . . N−1, one can compose a vector with vector elements xᵢ=e^{j·m·i2π/N} and combine these vector components in a beam-forming matrix B. It can be noticed that the vectors corresponding to m=N, N+1, N+2 repeat already composed vectors because of the periodicity a the function of e^{j·m·i2π/N}. Thus, for N different antenna elements 4-i, N different OAM states can be provided by the antenna array 2 with N elements according to the first aspect of the present invention.

In a circular MIMO array system as schematically illustrated in FIG. 2, the transmitting antenna array 2 and the receiving antenna array 3 can consist of directive antenna elements such as patches or horns being arranged uniformly along a circle with a large diameter. The diameter can be arbitrary configured and can comprise in a possible implementation a diameter of more than 10 cm at 2.4 GHz frequency region. In order to produce an electromagnetic beam with a certain OAM state, the antenna elements 4-i are fed with a linearly distributed phase in such a way that the incremental phase shift over the circle is 360 deg times an integer number as also shown in FIG. 3.

That is, a possible beam-forming matrix, B, is given as follows:

$$B = {( \begin{matrix}{k}_{1} & {k}_{2} & {k}_{3} & … & {k}_{N} \\ {k}_{1} & {k}_{2} \cdot {e}^{- j \cdot 1 \cdot \frac{2 π}{N} \cdot 1} & {k}_{3} \cdot {e}^{- j \cdot 2 \cdot \frac{2 π}{N} \cdot 1} & … & {k}_{N} \cdot {e}^{- j \cdot ( N - 1 ) \cdot \frac{2 π}{N} \cdot 1} \\ … & … & … & … & … \\ {k}_{1} & {k}_{2} \cdot {e}^{- j \cdot 1 \cdot \frac{2 π}{N} ( N - 2 )} & {k}_{3} \cdot {e}^{- j \cdot 2 \cdot \frac{2 π}{N} ( N - 2 )} & … & {k}_{N} \cdot {e}^{- j \cdot ( N - 1 ) \cdot \frac{2 π}{N} \cdot ( N - 2 )} \\ {k}_{1} & {k}_{2} \cdot {e}^{- j \cdot 1 \cdot \frac{2 π}{N} \cdot ( N - 1 )} & {k}_{3} \cdot {e}^{- j \cdot 2 \cdot \frac{2 π}{N} \cdot ( N - 1 )} & … & {k}_{N} \cdot {e}^{- j \cdot ( N - 1 ) \cdot \frac{2 π}{N} \cdot ( N - 1 )}\end{matrix} )}^{T}$$

wherein coefficients k1, k2 . . . kN are arbitrary real, or complex numbers. For example, the numbers k1, k2 . . . kN can be selected in a possible embodiment according to a water-filling algorithm. Each column of the beam-forming matrix elements are arranged with an incremental phase shift. As can be seen, the columns of the beam-forming matrix are orthogonal to each other.

In a compact form, matrix elements of the beam-forming matrix B can be expressed as:

$${B}_{mi} = {k}_{m} \cdot {e}^{\pm j \cdot \frac{2 π}{N} \cdot m \cdot i} ;$$

wherein

$$m = 0 , \pm 1 , \pm 2 … \leq \frac{N}{2} ;$$

i=0, 1, 2 . . . , N−1, wherein N is the total number of antenna elements, i is the number of a particular antenna element, and m is the number of the respective OAM state. The elements of the beam-forming, B, matrix can be realized or implemented both at chip as well as RF levels. The antenna array feeding circuit 9, 5 is adapted in a possible embodiment in a transmitting regime to provide transmit signal vectors applied to the antenna elements 4-i of the antenna array 2 by multiplying the beam-forming matrix B with input signal vectors corresponding to active ports. In a receiving regime the antenna array feeding circuit 5 can be adapted to multiply the beam-forming matrix, B, with reception signal vectors received from the antenna elements 4-i of the antenna array 2 to calculate output signal vectors.

In a case where a number of antenna elements 4-i within the antenna array is only N=2, the beam-forming matrix B is reduced to:

$$B = {( \begin{matrix}1 & - 1 \\ 1 & 1\end{matrix} )}^{T}$$

This corresponds to a 2×2 OAM based MIMO case in free space, which can be conveniently realized also at RF level for instance with a magic-T junction as also illustrated in FIG. 4. The magic-T or magic-T junction is a power splitter/combiner used in microwave systems. The magic-T is derived from the way in which power is divided among the various ports. A signal injected into the H-plane (so-called the sum) port of the magic-T is divided equally between two other ports and will be in-phase. A signal injected into the E-plane (difference), port is also divided equally between two ports, but will be 180 degrees out of phase.

In the implementation shown in FIG. 4 the transmitting antenna elements 4-1, 4-2 are connected to a magic-T junction 12 by means of metal waveguides 6-1, 6-2 as transmission lines. In the same manner receiving antenna elements 8-1, 8-2 of the receiving antenna array 3 are connected to a magic-T junction 13 via metal waveguides 10-1, 10-2. The transmitting antenna array 2 and the receiving antenna array 3 form a point-to-point communication system 1 having a transmitting antenna array 2 and a receiving antenna array 3 facing each other. The distance d between the transmitting antenna array 2 and the receiving antenna array 3 can vary depending on the application. The antenna elements within the antenna arrays 2,3 can be formed by directive antenna elements, for example a horn antenna or microwave horns. The horn antenna consists of a flaring metal wave guide shaped like a horn to direct radio waves in a beam. Since the horn antenna has no resonant elements it can operate over a wide range of frequencies, i.e. it has a wide bandwidth. In the embodiment shown in FIG. 4 in a special implementation only two antenna elements are provided in each antenna array 2,3. If OAM-0 port is port 1 and OAM-1 port is port 2, let us assume that the communication signal goes to port 1 only, while the second stream goes only to port 2. Accordingly, in this example the input signal matrix is given by:

$${\overline{x}}_{TX} = ( \begin{matrix}1 & 0 \\ 0 & 1\end{matrix} )$$

If the beam-forming matrix B is multiplied with the transmitted signal vector, then:

$${\overline{y}}_{TX} = B * {\overline{x}}_{TX} = ( \begin{matrix}1 & 1 \\ 1 & - 1\end{matrix} ) * ( \begin{matrix}1 & 0 \\ 0 & 1\end{matrix} ) = ( \begin{matrix}1 & 1 \\ 1 & - 1\end{matrix} )$$

At the receiving side, one has similar received signal vectors, because these vectors are the eigen vectors of the channel matrix H. If a signal combining circuit at the receiving side of the point-to-point communication system 1 uses the same beam forming matrix B it is possible to calculate the output signal vectors as follows:

$$\overline{x} \text{?} = B * \vec{y} = {( \begin{matrix}1 & 1 \\ 1 & - 1\end{matrix} )}^{} * ( \begin{matrix}{λ}_{1} \cdot 1 & {λ}_{2} \cdot 1 \\ {λ}_{1} \cdot 1 & {λ}_{2} \cdot ( - 1 )\end{matrix} ) = ( \begin{matrix}2 {λ}_{1} & 0 \\ 0 & 2 {λ}_{2}\end{matrix} )$$

$$\text{?} \text{indicates text missing or illegible when filed}$$

The signal arriving to port 1 at the transmitting side exits from the port 1 at the receiving side without influencing the second receiving port. Similarly, a signal at port 2 at the transmitting side exits from port 2 at the receiving side. Consequently, the point-to-point communication system 1 comprises two independent communication channels.

In a case where the antenna array 2, 3 comprises four antenna elements, the precoding beam-forming matrix B can be:

$$B = {( \begin{matrix}1 & 1 & 1 & 1 \\ 1 & j & - j & - 1 \\ 1 & - 1 & - 1 & 1 \\ 1 & - j & j & - 1\end{matrix} )}^{T}$$

In a similar manner, the transmitted signal vectors are as follows:

$${\overline{y}}_{TX} = ( \begin{matrix}1 & 1 & 1 & 1 \\ 1 & j & - j & - 1 \\ 1 & - 1 & - 1 & 1 \\ 1 & - j & j & - 1\end{matrix} ) ,$$

After propagation the electromagnetic beams through the channel, then:

$$\vec{y} \text{?} = ( \begin{matrix}{λ}_{0} & {λ}_{+ 1} \cdot 1 & {λ}_{- 1} \cdot 1 & {λ}_{2} \cdot 1 \\ {λ}_{0} & {λ}_{+ 1} \cdot j & {λ}_{- 1} \cdot ( - j ) & {λ}_{2} \cdot ( - 1 ) \\ {λ}_{0} & {λ}_{+ 1} \cdot ( - 1 ) & {λ}_{- 1} \cdot ( - 1 ) & {λ}_{2} \cdot 1 \\ {λ}_{0} & {λ}_{+ 1} \cdot ( - j ) & {λ}_{- 1} \cdot j & {λ}_{2} \cdot ( - 1 )\end{matrix} ) . \\ \text{?} \text{indicates text missing or illegible when filed}$$

If the conjugated beam-forming matrix B is multiplied by the y vectors, then:

$$\begin{matrix}\vec{x} \text{?} = ( \begin{matrix}1 & 1 & 1 & 1 \\ 1 & - j & - 1 & j \\ - & j & - 1 & - j \\ 1 & - 1 & 1 & - 1\end{matrix} ) * ( \begin{matrix}{λ}_{0} & {λ}_{+ 1} \cdot 1 & {λ}_{- 1} \cdot 1 & {λ}_{2} \cdot 1 \\ {λ}_{0} & {λ}_{+ 1} \cdot j & {λ}_{- 1} \cdot ( - j ) & {λ}_{2} \cdot ( - 1 ) \\ {λ}_{0} & {λ}_{+ 1} \cdot ( - 1 ) & {λ}_{- 1} \cdot ( - 1 ) & {λ}_{2} \cdot 1 \\ {λ}_{0} & {λ}_{+ 1} \cdot ( - j ) & {λ}_{- 1} \cdot j & {λ}_{2} \cdot ( - 1 )\end{matrix} ) = \\ = ( \begin{matrix}4 {λ}_{0} & 0 & 0 & 0 \\ 0 & 4 {λ}_{+ 1} & 0 & 0 \\ 0 & 0 & 4 {λ}_{- 1} & 0 \\ 0 & 0 & 0 & 4 {λ}_{2}\end{matrix} )\end{matrix}$$

$$\text{?} \text{indicates text missing or illegible when filed}$$

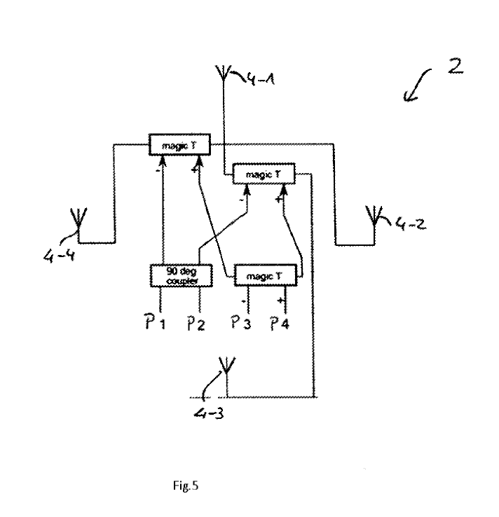

In a possible embodiment, conjugation is not necessary as it does result just in another position of two non-zero matrix elements. Thus, a signal coming to one port at the transmitting side, exits at one port at the receiving side leaving all the other ports isolated. This can be realized at chip level as well as at RF level, for instance by means of a so-called Butler matrix in an arrangement as shown in FIG. 5. FIG. 5 shows OAM beam-forming at an RF level with 4 antenna elements.

For the case of an arbitrary number of antenna elements, the element configuration and the phase distribution can be performed as illustrated in FIGS. 2 and 3. Again, a chip level beam-forming or a Butler matrix can be applied. A chip level beam-forming tends eventually to be more appropriate for a larger number N of antenna elements 4-i, 8-i.

For a LOS MIMO system and for a larger communication distance d, larger array dimensions are required. If the number of array elements of the antenna array 2, 3 is retained, the element separation distance between antenna elements 4-i, 8-i has to be increased which results in higher levels of side lobes. If the antenna element separation is large, side lobes are produced and a lot of radiated power is lost. On the other hand, a big area covered with antenna elements with a small element separation, for instance half of a wavelength means a large number of antenna elements and thus a huge complexity of the system. In order to avoid side lobe appearance, accordingly, one can keep the element separation between the antenna elements small and increase the number of antenna elements 4-i, 8-i however, this will cause a great complexity of the point-to-point communication system 1. Moreover, longer transmission lines connecting the antenna elements are needed, which causes additional difficulties.

Consequently, in a possible implementation of the antenna array 2, 3 according to the present invention, a compact circular antenna array 2, 3 is manufactured and used as a feed for a large collimating element. A compact circular antenna array 2, 3 can in a possible embodiment be integrated with the respective antenna array feeding circuit 5, 9 on a printed circuit board (PCB). Such collimating elements can be formed in a possible implementation by a parabolic reflector 14, 15 as illustrated in FIG. 6. In alternative implementations the collimating elements can also be formed by a collimating lens or a diffraction grating.

In the point-to-point communication system 1 as illustrated in the embodiment shown in FIG. 6, the point-to-point communication system 1 comprises a transmitting antenna array 2 and a receiving antenna array 3 which are integrated in the shown implementation on a PCB. The antenna array plane of the transmitting antenna array 2 integrated on the PCB is located at the focal plane of a first collimating element 14 formed by a parabolic reflector. In the same manner the antenna array plane of the receiving antenna array 3 integrated on a PCB is located at the focal plane of a second collimating element 15 also formed by a parabolic reflector. Between the transmitting antenna array 2 and the receiving antenna array 3 there is a LOS communication channel. In a possible embodiment of the point-to-point communication system 1 as illustrated in FIG. 6 both antenna arrays 2, 3 can both transmit as well as receive electromagnetic beams with variable OAM states. The point-to-point communication system 1 has circular antenna arrays with a quasi optical element formed by the collimating elements 14, 15. In a possible embodiment, the receiving part and the transmitting part can be formed by identical elements. In a possible embodiment, the point-to-point communication system 1 as shown in FIG. 6 provides a bidirectional transmission and reception of electromagnetic beams at the same time. FIG. 6 illustrates a parabolic 4×4 OAM based MIMO system according to a possible implementation of the present invention.

A field distribution is generated by the aperture of the parabolic reflector 14, 15 forming a virtual MIMO antenna array, wherein the element spacing is approximately as large as is the reflector. Depending on a phase distribution at the feeding antenna elements, a similar circular phase distribution can be created at the reflector aperture. A circular MIMO antenna array in a LOS scenario as illustrated in FIG. 6 automatically means exploiting the OAM states.

No modifications are needed in the input and output signals and only the size of the antenna array can be different at the input or output side of the point-to-point communication system 1 as illustrated in FIG. 6. In the shown embodiment, the antenna array 2, 3 is compact and placed approximately in the focal plane of the parabolic reflector 14, 15 forming the collimating element. The combination of a compact circular antenna array 2, 3 and the parabolic reflector as shown in FIG. 6 makes the overall system less expensive and easier to assemble compared to an array with widely spaced elements with matched connecting cable lengths.

Non-diffractive Bessel beams are known to have a peak(s) in the field strength at the middle (may be zero exactly in the center). Strictly speaking, Bessel beams require an infinitely large aperture, however, if the aperture is truncated, the resulting beam still can be maintained over a certain distance. Such quasi-Bessel beams or pseudo-Bessel beams can be produced in optics e.g. with an annular aperture followed by a lens. At microwaves, the annular or circular aperture can be approximately reproduced with a circular antenna array. If such an antenna array is combined with a quasi-optical element such as a lens or with a parabolic reflector as illustrated in FIG. 6, one can also produce Bessel beams. In the embodiment shown in FIG. 6 the transmitting and receiving side can be identical and aligned along the propagation axis. In both sides, a circular antenna array 2, 3 is placed approximately in the focal plane of the respective parabolic reflector 14, 15. For use of an antenna array, it is also convenient to introduce variations of the field phase of the electromagnetic field around the propagation axis, that is OAM states. In order to maximize the transmission coefficient of a higher OAM mode, the feeding array position can be adjusted. Since the electromagnetic beam carrying a non-zero OAM state comprises a zero-field at the center, the reflected beam is nearly unobstructed by the feeding array.

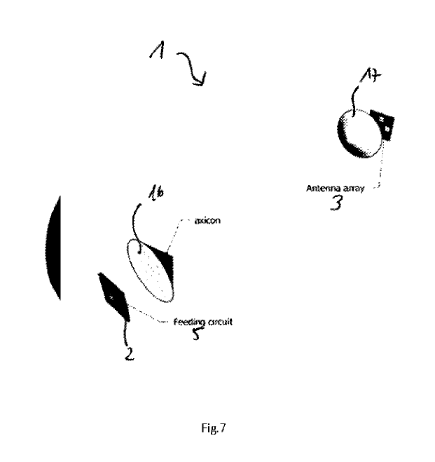

A further possible implementation of a point-to-point communication system 1 is shown in FIG. 7. In this embodiment shown in FIG. 7 the antenna array 2 has antenna array elements which are arranged around the common axis in a plane being parallel to a base plane of a conical lens 16. This conical lens can also be called an axicon. In the implementation shown in FIG. 7 the point-to-point communication system 1 comprises a first conical lens 16 and a second conical lens 17. The conical lens 16 is adapted to transform incident Lagger-Gaussian electromagnetic beams radiated by the antenna array 2 to a base plane of the conical lens 16 into Bessel electromagnetic beams which are then transmitted to the lateral surface of the second conical lens 17 as illustrated in FIG. 7. The first conical lens 16 is further adapted to transform incident Bessel electromagnetic beams supplied to a lateral surface of the conical lens 16 into Lagger-Gaussian electromagnetic beams applied to the antenna array 2. The Bessel electromagnetic beams radiating from the lateral surface of the first conical lens 16 are transmitted to the lateral surface of the second conical lens 17 as illustrated in FIG. 7, where they are retransformed to Lagger-Gaussian electromagnetic beams applied to the second antenna array 3. The two conical lenses 16, 17 can be similar in shape each having a base plane facing the corresponding antenna array 2, 3. The lateral surfaces of the conical lenses 16, 17 face each other at a predetermined distance, of e.g. 10 m. The distance between the antenna array 2, 3 and the associated conical lens 16, 17 can be adjustable and be in a range corresponding to approximately one wavelength of the beams.

In a possible implementation the antenna array 2, 3 according to the first aspect of the present invention comprises at least two antenna elements which can be seen as arranged in a circular arrangement, because it is possible to draw a circle through the location of the antenna elements in such a way that these antenna elements are uniformly spaced along the circle, i.e. at the diameter of the circle. If two such antenna elements of an antenna array are fed in counter-phase, in a sense, two beams are generated with OAM states +1 and −1, and they sum up in two ordinary beams. This situation is similar to the situation when two electromagnetic waves, one with left-hand and the other with right-hand polarization, compose an ordinary linearly polarized wave.

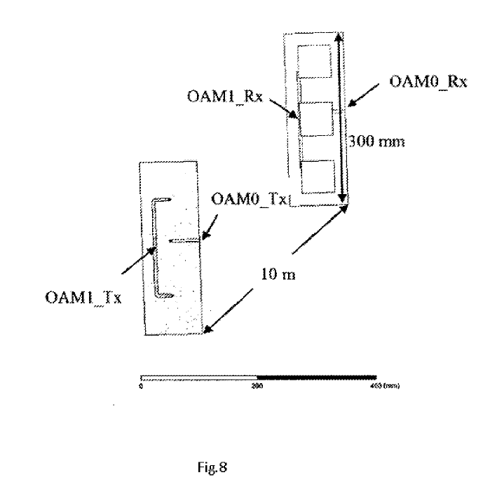

In FIG. 8 a configuration of a MIMO system is shown which is modelled with HFSS. For the sake of simplicity, the antenna elements producing/receiving ordinary beams (OAM=0) at the receiving and at the transmitting parts are shown as ordinary patch antennas (ports OAM0Tx and OAM0Rx) and placed in the middle of the shown structure. In order to produce a beam with OAM state=1, two antenna elements fed in counter-phase are provided. This can be done with two patch antennas connected with a microstrip line and a port in the middle (see ports OAM1Tx and OAM1Rx). All patch dimensions and probe positions can be adjusted to provide minimal reflections.

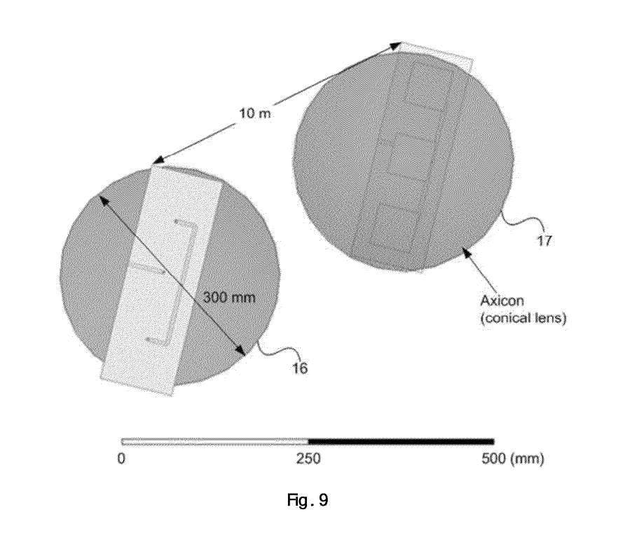

In order to evaluate the influence of quasi-optical elements, e.g. the two conical lenses or axicons, these elements are added to the same setup and the simulation results can be compared with each other. The configuration comprising axicons or conical lenses 16, 17 is illustrated in FIG. 9. The calculation results are summarized in the following table:

| | Configuration | |
|---|---|---|
| | “Simple” | With axicons |
| Transmission, OAM = 0, in dB | −42.7 | −32.8 |
| Transmission, OAM = 1, in dB | −64.3 | −50.9 |

As can be seen, there are improvements of more than 10 dB in the transmission coefficient for the ordinary antenna elements and even higher, i.e. 13.6 dB for the other channel. That means that, at finite communication distances, it is possible to improve the signal-to-noise ratio, SNR, for all data channels, and consequently the overall signal data rate significantly. Similar effects can be obtained with dielectric lenses and parabolic reflectors.

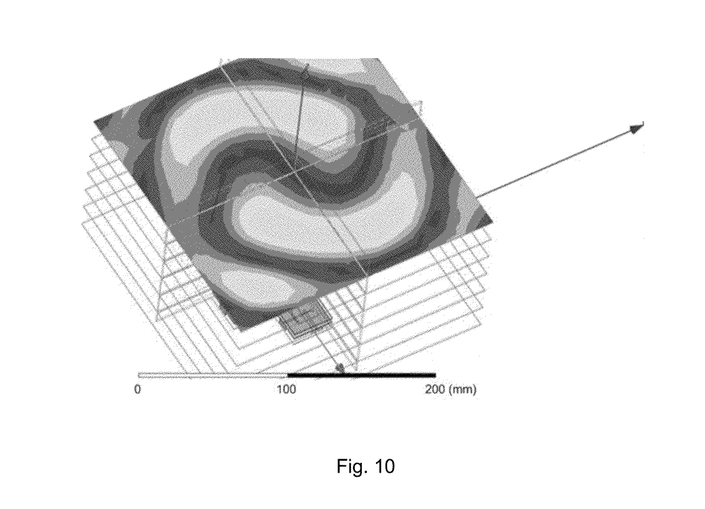

FIG. 10 shows a field distribution on an electromagnetic field produced by a circular 4 element patch array, when the antenna elements are fed with a 90 degree phase shift. In a HFSS window, the pattern shown in FIG. 10 does rotate, when the animation mode HFSS is switched on.

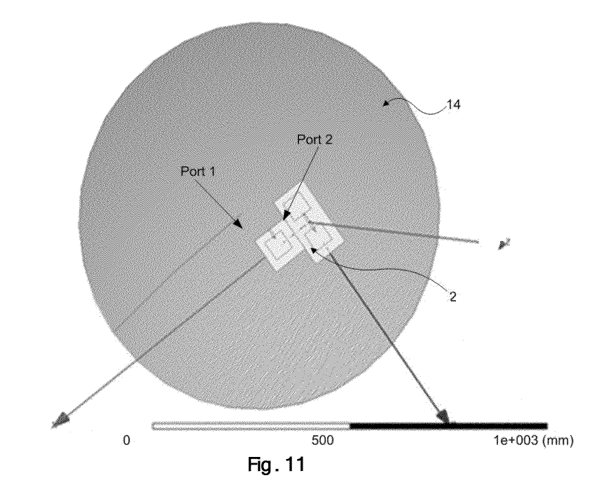

A possible implementation of a parabolic MIMO antenna system according to an aspect of the present invention is shown in FIG. 11. For the sake of simplicity, a two-port configuration is shown. In order to generate an ordinary electromagnetic beam, one antenna element is sufficient. In order to generate an OAM-1 beam, two patch antenna elements are fed in counter-phase. A simple implementation of this is shown in FIG. 11 at port 2. In a possible implementation, three patch antennas with 100×100 mm2 square ground planes are put in a focal plane of the parabolic reflector having a diameter of 1 m and the focal distance of 0.5 m. The radiating direction is toward the parabolic reflector and the patch antennas are located in fact behind the ground plane. Such a combined system can be used as a transmitting part of a point-to-point communication system 1. An identical system can be placed 150 m apart and be provided for receiving the signals. Such a model can be calculated with HFSS, for instance for a frequency of 2.45 GHz. The calculated transmission results are as following:

| | From → to | |
|---|---|---|
| | 1→1 | 2→2 |
| Transmission, dB | −58 | −71 |
| Parasitic coupling, dB | −86 | −84 |

In MIMO systems, the so-called condition ratio, i.e. the largest eigen value of the channel matrix divided by the smallest eigen value, are considered to be acceptable, if the condition ratio does not exceed 10. That is, 20 dB difference in channel transmission coefficients is deemed to be satisfactory. Using the calculated transmission results, in this case the difference in channel transmission coefficients is: −58−(−71)=13 dB≦20 dB. Similar MIMO systems can be designed in an alternative implementation with four antenna elements. According to a further aspect of the present invention a MIMO antenna system is provided comprising at least one antenna array which has antenna elements arranged along a circle adapted to generate or receive electromagnetic beams with variable OAM states.

According to a still further aspect of the present invention, a method for generating electromagnetic beams with variable OAM states is provided. In a possible implementation of this method, input signal vectors of input data streams are multiplied with a beam-forming matrix, B, to calculate transmit signal vectors applied to antenna elements arranged uniformly along a circle in an array plane of an antenna array to generate the electromagnetic beams with variable OAM states.

According to a further aspect of the present invention, a method for receiving electromagnetic beams with variable OAM states is provided. In a possible implementation of this method, reception signal vectors provided by antenna elements arranged uniformly along a circle in an array plane of an antenna array in response to incident electromagnetic beams with variable OAM states are multiplied with a beam-forming matrix, B, to calculate output signal vectors of output data streams. The methods for generating and/or receiving electromagnetic beams with variable OAM states can be performed in a possible embodiment by a computer program comprising instructions for performing the steps of the respective method. This program can be stored in a program memory of a device.

The method and apparatus for generating or receiving electromagnetic beams with variable OAM states can be used in a stationary communication system 1, in particular a point-to-point communication system such as radio relay links, fixed point-to-point wireless links, spot communication systems, in particular when multiple high data rate streams have to be transmitted independently over the same frequency band in the same direction and at the same polarization. According to an aspect of the present invention, an antenna array comprising antenna elements arranged along a circle are provided which radiate beams directed normal to the array plane, with a beam-forming matrix used for generating electromagnetic beams with desired OAM states.

The precoding can be performed both at the baseband and RF levels. Conventional beam-forming signal processing techniques can be applied in the device.

The combination of a circular MIMO antenna array with a parabolic reflector or a lens or a conical lens or any other quasi-optical elements can be used for maximizing the transmission coefficient at higher OAM states. The combination of a compact circular antenna array and a parabolic reflector makes the overall system less expensive. Moreover, the system can be more easily assembled compared to an array with widely spaced antenna elements where matched connecting cable lengths are necessary. The non-diffractive beams are launched and received with a small attenuation and can be maintained over certain distance after which they dissolve and do not produce any considerable interference.

What is claimed is:

1. An antenna array, comprising:
antenna elements arranged along a circle that are adapted to generate or receive electromagnetic beams with variable orbital angular momentum (OAM) states, wherein the antenna elements are arranged uniformly in an array plane along the circle and the antenna elements are connected via connection lines to an antenna array feeding circuit; and
the antenna array feeding circuit, adapted to provide transmit signal vectors to the antenna elements by multiplying a beam-forming matrix (B) with input signal vectors corresponding to active input ports, and further adapted to calculate output signal vectors by multiplying the beam-forming matrix (B) with reception signal vectors received from the antenna elements.

2. The antenna array according to claim 1 wherein the antenna elements are arranged in the array plane which has an orientation being normal to a propagation direction of the electromagnetic beams generated or received by the antenna array.

3. The antenna array according to claim 2 wherein the array plane of said antenna array is located at a focal plane of a collimating element.

4. The antenna array according to claim 3 wherein the collimating element comprises a parabolic reflector, a collimating lens or a diffraction grating.

5. The antenna array according to claim 1 wherein the antenna array elements are arranged around the common axis in a plane that is parallel to a base plane of a conical lens.

6. The antenna array according to claim 5 wherein the conical lens is adapted to transform incident Lagger-Gaussian electromagnetic beams radiated by the antenna array to a base plane of the conical lens into Bessel electromagnetic beams, and is further adapted to transform incident Bessel electromagnetic beams applied to a lateral surface of the conical lens into Lagger-Gaussian electromagnetic beams applied to the antenna array.

7. The antenna array according to claim 1, wherein the antenna elements comprise directive antenna elements.

8. The antenna array according claim 1, wherein the antenna elements are connected to outputs of the feeding circuit.

9. The antenna array according to claim 8 wherein the antenna elements are connected via transmission lines and signal coupling elements to the outputs of the feeding circuit.

10. The antenna array according to claim 1 wherein the antenna array feeding circuit comprises a baseband/radio frequency converter adapted to perform a transformation between a baseband signal and a radio frequency signal used by the antenna elements.

11. The antenna array according to claim 1 wherein the antenna array is adapted to radiate electromagnetic beams to a remote antenna array and to receive electromagnetic beams from the remote antenna array.

12. The antenna array according to claim 1 wherein the antenna array and the antenna array feeding circuit are integrated on a printed circuit board (PCB).

13. The antenna array according to claim 1, wherein the beam-forming matrix (B) consists of N×N complex beam-forming matrix elements Bₘᵢ, wherein Bₘᵢ is determined according to the following relation:
$${B}_{mi} = {k}_{m} \cdot {e}^{\pm j \cdot \frac{2 Π}{N} m \cdot i} ,$$
wherein N is the total number of antenna elements within the antenna array, m is a OAM state number of a OAM state and is an integer that is less than or equal to N/2, i is the number of a particular antenna element within the antenna array and includes positive integers from 0 to N−1 inclusive, and kₘ is a normalizing coefficient.

14. A multiple input and multiple output (MIMO) antenna system, comprising at least one antenna array according to claim 1.

15. A point-to-point communication system, comprising:
at least one transmitting antenna array having antenna elements arranged along a circle that are adapted to generate electromagnetic beams with variable orbital angular momentum (OAM) states; and
at least one receiving antenna array having antenna elements arranged along a circle that are adapted to receive electromagnetic beams with variable OAM states.

16. A method for generating electromagnetic beams with variable orbital angular momentum (OAM) states, comprising:
determining a beam-forming matrix (B);
multiplying input signal vectors of input data streams with the beam-forming matrix (B) to calculate transmit signal vectors; and
applying the transmit signal vectors to antenna elements that are arranged uniformly along a circle in an array plane of an antenna array to generate electromagnetic beams with variable OAM states.

17. A method for receiving electromagnetic beams with variable orbital angular momentum (OAM) states, comprising:
determining a beam-forming matrix (B);
creating reception signal vectors by receiving incident electromagnetic beams with variable OAM states by antenna elements arranged uniformly along a circle in an array plane of an antenna array; and
calculating output signal vectors of output data streams by multiplying the reception signal vectors with the beam-forming matrix (B).
